(19) United States
(12) Patent Application Publication
(10) Pub. No.: US 2014/0242452 A1
(43) Pub. Date: Aug. 28, 2014

(54) LITHIUM ION BATTERY

(71) Applicant: GM GLOBAL TECHNOLOGY OPERATIONS LLC, Detroit, MI (US)

(72) Inventors: Nicholas P. W. Pieczonka, Windsor (CA); Junghyun Kim, Troy, MI (US); Zicheng Li, Sterling Heights, MI (US); Timothy J. Fuller, Pittsford, NY (US); Nicholas P. Irish, Milford, MI (US); Bob R. Powell, JR., Birmingham, MI (US); Ion C. Halalay, Grosse Pointe Park, MI (US)

(73) Assignee: GM GLOBAL TECHNOLOGY OPERATIONS LLC, Detroit, MI (US)

(21) Appl. No.: 13/778,968

(22) Filed: Feb. 27, 2013

(51) Int. Cl. H01M 4/62

(52) U.S. Cl. CPC H01M 4/622
USPC 429/188; 252/182.1

(57) ABSTRACT

A lithium-ion cell has a positive electrode comprising at least one active material comprising a lithium transition metal compound in a binder comprising at least one binder material with functional groups selected from alkali and alkaline earth salts of acid groups and hydroxyl groups, amine groups, isocyanate groups, urethane groups, urea groups, amide groups, and combinations of these; a negative electrode comprising metallic lithium or a lithium host material with appropriately low operation voltage vs. metallic lithium; a nonaqueous solution of a lithium salt; and an electrically nonconductive, ion-pervious separator positioned between the electrodes.

### FIELD

The present disclosure is in the field of secondary lithium-ion cells and batteries and methods of making and using such cells and batteries.

### BACKGROUND

This section provides background information related to the present disclosure that is not necessarily prior art.

Secondary, or rechargeable, lithium ion batteries are well known and often used in many stationary and portable devices such as those encountered in the consumer electronic, automotive, and aerospace industries. The lithium ion class of batteries has gained popularity for various reasons including a relatively high energy density, an absence of memory effect when compared to other kinds of rechargeable batteries, a relatively low internal resistance, and a relatively low self-discharge rate when not in use.

A lithium ion battery or cell generally operates by reversibly passing lithium ions between a negative electrode (sometimes called the anode) and a positive electrode (sometimes called the cathode). The negative and positive electrodes are situated on opposite sides of an insulating microporous polymer separator that is soaked with an electrolyte solution suitable for conducting lithium ions. Each of the negative and positive electrodes is deposited, respectively, on a copper or aluminum current collector that also possesses a tab that ensures a connection to an external circuit via a battery terminal. The terminal is in turn connected into an interruptible external circuit that allows an electric current to pass on the outside of the battery to electrically balance the related migration of lithium ions inside the battery. In general, the positive electrode typically includes a lithium-based active intercalation material such as a lithium transition metal oxide, the negative electrode typically includes a lithium host material such as graphite that can store lithium at a lower energy state than can the active intercalation host material of the positive electrode, and the electrolyte solution typically contains a lithium salt dissolved in a non-aqueous solvent.

A lithium ion battery, or a plurality of lithium ion batteries that are connected in combination of series or parallel configurations or both can be utilized to supply electrical energy to an associated load device. When fully charged, the positive electrode of a lithium ion battery has a very low concentration of intercalated lithium while the negative electrode is correspondingly lithium-rich. Closing an external circuit between the negative and positive electrodes under such circumstances causes the extraction of intercalated lithium from the negative electrode. The extracted lithium is then split into lithium ions and electrons. Lithium ions are carried through the micropores of the polymer separator from the negative electrode to the positive electrode by the ionically conductive electrolyte solution while, at the same time, the electrons are transmitted through the external circuit from the negative electrode to the positive electrode to balance the overall electrochemical cell. At the same time, Li⁺ ions from the solution recombine with electrons at interface between the electrolyte and the positive electrode, and the lithium concentration in the active material of the positive electrode increases. The flow of electrons through the external circuit can be harnessed and fed to a load device until the level of intercalated lithium in the negative electrode falls below a workable level or the need for electrical energy ceases.

The lithium ion battery may be recharged after a partial or full discharge of its available capacity for charge storage. To charge the lithium ion battery, an external electrical energy source is connected to the positive and the negative electrodes to drive the reverse of battery discharge electrochemical reactions. That is, during charging, the external power source extracts the intercalated lithium present in the positive electrode to produce lithium ions and electrons. The lithium ions are carried back through the separator by the electrolyte solution and the electrons are driven back through the external circuit, both towards the negative electrode. The lithium ions and electrons are ultimately reunited at the negative electrode thus replenishing it with intercalated lithium for future battery discharge.

The ability of lithium ion batteries to undergo such repeated charge cycling over their useful lifetimes makes them an attractive and dependable electrical energy source. Lithium ion batteries now known, however, suffer shortened lifetimes due to poisoning of the negative electrode's graphite or other intercalation host material with transition metals such as manganese transmitted from the lithium active transition metal compound of the positive electrode. Further, the deposited manganese or other transition metal may act as a catalyst for a reductive decomposition of the electrolyte to irreversibly bind lithium, causing the lithium ion battery to gradually lose capacity.

For example, spinel lithium manganese oxide (LiₓMn₂O₄) that may be present in the positive electrode may leach Mn⁺² cations into the electrolyte solution during normal operation of the lithium ion battery. These mobile Mn⁺² cations can migrate through the electrolyte solution and across the microporous polymer separator to the negative electrode and tend to undergo a reduction reaction and deposit on the graphite surface because the standard redox potential of Mn/Mn(II) is much higher than that of lithium intercalation into graphite. The deposited manganese on the graphite in the negative electrode may catalyze the reduction of solvent molecules (depending on the solvent) at the contaminated interface of the negative electrode and the electrolyte solution, which may evolve gaseous decomposition products. Furthermore, manganese deposition on the edge planes of graphite particles will prevent the intercalation of lithium. A similar poisoning may take place with other transition metal active materials (e.g., cobalt cations from lithium cobalt oxide (LiCoO₂), iron cations from lithium iron phosphate (LiFePO₄), or nickel as well as cobalt cations from ternary mixed Ni—Mn—Co oxides) when used in the positive electrode. The presence of HF in the electrolyte solution (generated though the hydrolysis reaction of the LiPF₆ salt) can further exacerbate the dissolution of manganese or other transition metals from the positive electrode.

Any amount of metal cations leached from the positive electrode can poison large areas of the graphite or other intercalation host material in the negative electrode and reduce the capacity of the lithium ion battery.

### SUMMARY

This section provides a general summary rather than a comprehensive disclosure of the invention and all of its features.

Disclosed is a lithium ion cell or battery that has (a) a negative electrode including at least one active material including metallic lithium or a lithium host material with appropriately low operation voltage vs. metallic lithium, such as a carbonaceous material (like graphite or petroleum coke) or a transition metal compound (such as titanium dioxide or tin oxide), silicon, or silicon oxides; (b) a positive electrode including a lithium transition metal compound (such as a transition metal oxide, a mixed transition metal oxide, or a transition metal phosphate) and at least one binder material with functional groups selected from alkali and alkaline earth salts of acid groups and hydroxyl groups, amine groups, isocyanate groups, urethane groups, urea groups, amide groups, and combinations of these; (c) a nonaqueous solution of a lithium salt; and (d) an electrically nonconductive, ion-pervious separator positioned between the electrodes. The binder material may be a polymer or oligomer. In this specification, the term “polymer” as used encompasses oligomers as well.

The disclosed lithium-ion batteries have improved durability, cycle life, and coulombic efficiency. In various embodiments, the functional binders can keep electrolyte decomposition species from fouling active material particle surfaces. In particular embodiments, the functional binders can trap transition metal cations such as Mn², Ni², Fe², and Co⁺² that leach from the active material into the negative electrode, preventing those cations from fouling active material particle surfaces in the negative electrode.

In discussing the disclosed technology, “a,” “an,” “the,” “at least one,” and “one or more” are used interchangeably to indicate that at least one of the items is present; a plurality of such items may be present unless the context clearly indicates otherwise. “About” indicates that the stated numerical value or amount allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. The terms “comprises,” “comprising,” “including,” and “having,” are inclusive and therefore specify the presence of stated items, but do not preclude the presence of other items. The term “or” includes any and all combinations of one or more of the associated listed items.

Further areas of applicability will become apparent from the description provided herein. The description and specific examples in this summary are intended for purposes of illustration only and are not intended to limit the scope of the present disclosure.

### DRAWINGS

The drawings illustrate some aspects of the disclosed technology.

FIG. 1 is schematic illustration of one configuration for a lithium ion cell;

FIGS. 2a and 2b are graphs of specific discharge capacity and columbic efficiency, respectively, versus number of cycles at 45° C. for a first inventive cell compared to a prior art cell;

FIGS. 3a and 3b are graphs of specific discharge capacity and columbic efficiency, respectively, versus number of cycles at 30° C. for the first inventive cell compared to the prior art cell;

FIGS. 4a and 4b are graphs of specific discharge capacity and columbic efficiency, respectively, versus number of cycles at 45° C. for a second inventive cell compared to a prior art cell; and

FIGS. 5a and 5b are graphs of specific discharge capacity and columbic efficiency, respectively, versus number of cycles at 30° C. for the second inventive cell compared to the prior art cell.

### DETAILED DESCRIPTION

A detailed description of exemplary, nonlimiting embodiments follows.

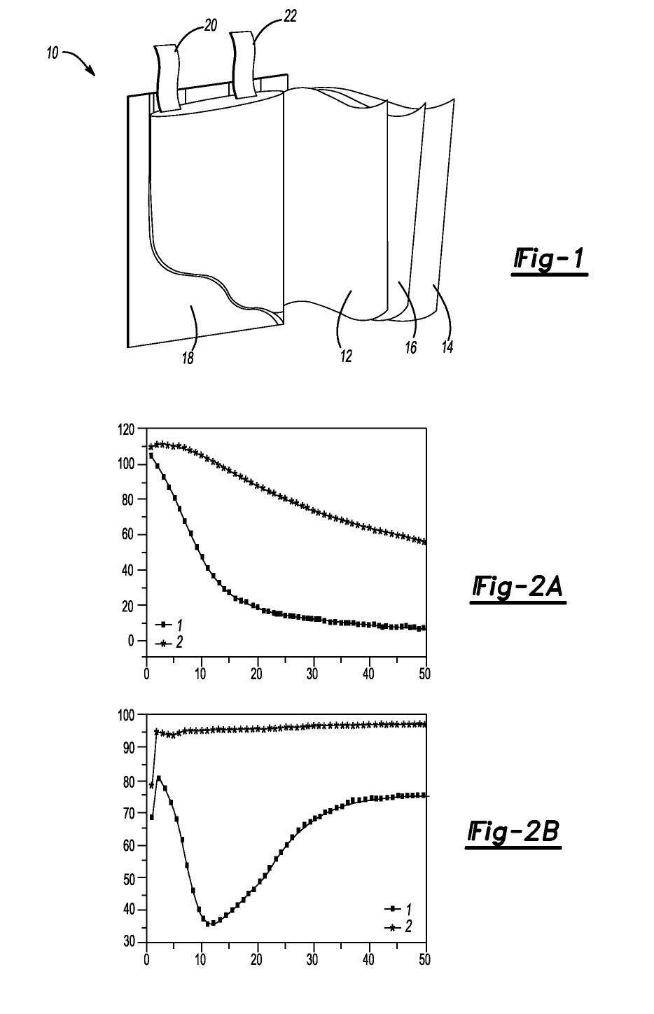

Referring first to the Figures, FIG. 1 illustrates one configuration for a lithium ion cell or battery 10 in which sheets of a negative electrode 12 and positive electrode 14, separated by a sheet of a polymer separator 16, are wound together or stacked in alternation inside of a cell enclosure 18. The polymer separator 16 is electrically nonconductive and ion-pervious via the electrolyte solution that fills its open pores. For example the polymer separator 16 is a microporous polypropylene or polyethylene sheet. The separator 16 contains a nonaqeuous lithium salt electrolyte solution to conduct lithium ions between the electrodes. The negative electrode connects to a negative electrode current collector 20; the positive electrode connects to a positive electrode current collector 22. The terminals can be connected in a circuit to either discharge the battery by connecting a load (not shown) in the circuit or charge the battery by connecting an external power source (not shown).

The lithium ion cell can be shaped and configured to specific uses as is known in the art. For examples, the loads may be electric motors for automotive vehicles and aerospace applications, consumer electronics such as laptop computers and cellular phones, and other consumer goods such as cordless power tools, to name but a few. The load may also be a power-generating apparatus that charges the lithium ion battery 10 for purposes of storing energy. For instance, the tendency of windmills and solar panel displays to variably and/or intermittently generate electricity often results in a need to store surplus energy for later use. Lithium ion batteries often are configured in four general ways: (1) as small, solid-body cylinders such as laptop computer batteries; (2) as large, solid-body cylinders with threaded terminal; (3) as soft, flat pouches, such as cell phone batteries with flat terminals flush to the body of the battery; and (4) as in plastic cases with large terminals in the form of aluminum and copper sheets, such as battery packs for automotive vehicles.

The lithium ion battery 10 can optionally include a wide range of other components known in the art, such as gaskets, seals, terminal caps, and so on for performance-related or other practical purposes. The lithium ion battery 10 may also be connected in an appropriately designed combination of series and parallel electrical connections with other similar lithium ion batteries to produce a greater voltage output and current if the load so requires.

The lithium ion battery 10 can generate a useful electric current during battery discharge by way of reversible electrochemical reactions that occur when an external circuit is closed to connect the negative electrode 12 and the positive electrode 14 at a time when the positive electrode 14 contains electrochemically active lithium. The average chemical potential difference between the positive electrode 14 and the negative electrode 12—about 3.7 to 4.8 volts depending on the exact chemical make-up of the electrodes 12, 14—drives the electrons produced by the oxidation of intercalated lithium at the negative electrode 12 through an external circuit towards the positive electrode 14. Concomitantly, lithium ions produced at the negative electrode are carried by the electrolyte solution through the microporous polymer separator 16 towards the positive electrode 14. At the same time with Li⁺ ions entering the solution at the negative electrodes, Li⁺ ions from the solution recombine with electrons at interface between the electrolyte and the positive electrode, and the lithium concentration in the active material of the positive electrode increases. The electrons flowing through an external circuit reduce the lithium ions migrating across the microporous polymer separator 16 in the electrolyte solution to form intercalated lithium at the positive electrode 14. The electric current passing through the external circuit can be harnessed and directed through the load until the intercalated lithium in the negative electrode 12 is depleted and the capacity of the lithium ion battery 10 is diminished below the useful level for the particular practical application at hand.

The lithium ion battery 10 can be charged at any time by applying an external power source to the lithium ion battery 10 to reverse the electrochemical reactions that occur during battery discharge and restore electrical energy. The connection of an external power source to the lithium ion battery 10 compels the otherwise non-spontaneous oxidation of intercalated lithium at the positive electrode 14 to produce electrons and lithium ions. The electrons, which flow back towards the negative electrode 12 through an external circuit, and the lithium ions, which are carried by the electrolyte across the polymer separator 16 back towards the negative electrode 12, reunite at the negative electrode 12 and replenish it with intercalated lithium for consumption during the next battery discharge cycle.

The negative electrode 12 may include any lithium host material that can sufficiently undergo lithium intercalation and deintercalation while functioning as the negative terminal of the lithium ion battery 10. Examples of host materials include electrically conductive carbonaceous materials such as carbon, graphite, carbon nanotubes, graphene, and petroleum coke, as well as transition metals and their oxides such as titanium dioxide, tin oxide, iron oxides, and manganese dioxide, or silicon and silicon oxides. Mixtures of such host materials may also be used. Graphite is widely utilized to form the negative electrode because it is inexpensive, exhibits favorable lithium intercalation and deintercalation characteristics, is relatively non-reactive, and can store lithium in quantities that produce a relatively high energy density. Commercial forms of graphite that may be used to fabricate the negative electrode 12 are available from, for example, Timcal Graphite & Carbon, headquartered in Bodio, Switzerland, Lonza Group, headquartered in Basel, Switzerland, Superior Graphite, headquartered in Chicago, USA, or Hitachi Chemical Company, located in Japan.

The negative electrode 12 includes a polymer binder material in sufficient amount to structurally hold the lithium host material together. Nonlimiting examples of suitable binder polymers include polyvinylidene fluoride, polyacrylonitrile, polyethylene oxide, polyethylene, polypropylene, polytetrafluoroethylene, polybutadiene, polystyrene, polyalkyl acrylates and methacrylates, ethylene-(propylene-diene-monomer)-copolymer (EPDM) rubber, copolymers of styrene and butadiene, and mixtures of such polymers.

The negative electrode current collector 20 may be formed from copper or any other appropriate electrically conductive material known to skilled artisans.

In general, the positive electrode active materials are generally one or a combination of three kinds of materials: a layered oxide such as lithium cobalt oxide (LiCoO₂); a polyanion such as lithium iron phosphate; or a spinel such as lithium manganese oxide. In some embodiments the positive electrode may comprises a lithium- transition metal compound of formula LiMPO₄, wherein M is at least one transition metal of the first row of transition metals in the periodic table, more preferably a transition metal selected from Mn, Fe, Ni, and Ti or a combination of these elements. Other useful lithium-containing active materials are lithium-containing transition metal compounds such as lithium-containing mixed transition metal oxides. Other examples of useful active materials include lithium nickelate (LiNiO₂), lithium-containing nickel-cobalt-manganese oxides with layer structure, and manganese-containing spinels doped with one or more transition metals, including those having a formula LiₐM_{b}Mn_{3-a-b}O_{4-d} in which 0.9≦a≦1.3, preferably 0.95≦a≦1.15; 0≦b≦0.6, and when M is Ni preferably 0.4≦b≦0.55; -0.1≦d≦0.4, preferably 0≦d≦0.1; and M is selected from Al, Mg, Ca, Na, B, Mo, W, transition metals from the first row of the Periodic Table, and combinations of these, preferably Ni, Co, Cr, Zn, and Al, and more preferably Ni; and manganese-containing mixed transition metal oxides with layer structure especially including Mn, Co, and Ni.

The lithium-transition metal compound may be present in a particulate form, for example in the form of nanoparticles. The nanoparticles may have any shape, i.e. they may be approximately spherical or may be elongated.

The positive electrode may also include a carbonaceous material or other electrically conductive material, such as an electrically conductive intermetallic compound. The electrically conductive, high surface area carbon black ensures electrical connectivity between the current collector and active material particles in the positive electrode.

The materials of the positive electrode, including the active lithium- transition metal compound and conductive carbon, are held together by means of a binder. The binder of the positive electrode 14 includes at least one binder material with functional groups selected from alkali and alkaline earth salts of acid groups and hydroxyl groups, amine groups, isocyanate groups, urethane groups, urea groups, amide groups, and combinations of these.

Nonlimiting examples of polymers having alkali and alkaline earth salts of acid groups or hydroxyl groups, or having combinations of these groups, include homopolymers and copolymers such as

(i) alkali and alkaline earth salts of polymers and copolymers of ethylenically unsaturated acids such as acrylic acid, methacrylic acid, crotonic acid, α-ethacrylic acid, vinylacetic acid, acryloxypropionic acid, maleic acid and its monoesters, itaconic acid and its monoesters, fumaric acid and its monoesters, mesaconic acid and its monoesters, citraconic acid and its monoesters, 4-vinylbenzoic acid and anhydrides of these, sulfopropyl acrylate, sulfoethyl acrylate, sulfoethyl methacrylate, sulfoethyl methacrylate, styrenesulfonic acid, vinylsulfonic acid, vinylphosphonic acid, phosphoethyl acrylate, phosphonoethyl acrylate, phosphopropyl acrylate, phosphonopropyl acrylate, phosphoethyl methacrylate, phosphonoethyl methacrylate, phosphopropyl methacrylate and phosphonopropyl methacrylate, and the like, including polyacrylic acid, polymethacrylic acid, poly[ethylene-co-(maleic acid)], poly[styrene-co-(maleic acid)], poly[styrene-co-(acrylic acid)], poly[vinylpyridine-co-(methacrylic acid)], poly[(vinylidene chloride)-co-ethylene co-(acrylic acid)], poly[(methyl vinyl ether)-co-(maleic acid)], polyvinylbenzoic acid, and poly(perfluorosulfonic acid), poly[(vinyl chloride)-co-(vinyl acetate)-co-(maleic acid)], poly[(ethylene-co-(acrylic acid)], poly[(ethylene-co-(methacrylic acid)], as well as the alkali and alkaline earth salts of the reaction products of such polymers with a monoepoxide such as ethylene oxide;

(ii) alkali and alkaline earth salts of carboxylated polyvinyl chloride;

(iii) alkali and alkaline earth salts of polyvinyl alcohol and copolymers with vinyl alcohol monomer units, such as the copolymer of ethylene and vinyl alcohol, and the alkali and alkaline earth metal salts of these polymers;

(iv) alkali and alkaline earth salts of polysaccharides such as cellulose and its derivatives such as partially hydrolyzed cellulose esters and ethers, hydroxyethyl cellulose, hydroxypropyl cellulose, hydroxypropyl methyl cellulose, hydroxybutyl methyl cellulose, carboxymethyl cellulose, and alkali and alkaline earth metal alginates,

(v) alkali and alkaline earth salts of polyundecylenol and copolymers of olefins and undecylenol, polyundecylenic acid and copolymers of olefins and undecylenic acid;

(vi) alkali and alkaline earth salts of maleated or fumerated polymers and monoesters of these, such as maleated polyolefins such as maleated polypropylene and maleated polyethylene, maleated ethylene-vinyl acetate copolymers, maleated ethylene-methyl acrylate copolymers, maleated ethylene-propylene copolymers, maleated styrene-ethylene-butene-styrene triblock copolymers, maleated polybutadiene, and maleated ethylene-propylene-diene copolymers;

(vii) alkali and alkaline earth salts of homopolymers and copolymers of ethylenically unsaturated alcohols such as hydroxyethyl acrylate, hydroxyethyl methacrylate, hydroxypropyl acrylate, hydroxypropyl methacrylate, hydroxybutyl acrylate, hydroxybutyl methacrylate, polyglycol esters of ethylenically unsaturated acids such as poly(ethylene glycol) acrylate, vinylbenzyl alcohol, and allyl alcohol, for example polyvinylbenzyl alcohol, poly[styrene-co-(allyl alcohol)], polyallyl alcohol, polymethyl allyl alcohol, poly[vinylpyridine-co-(allyl alcohol)], poly[ethylene-co-(allyl alcohol)], and poly[styrene-co-(hydroxyethyl methacrylate)];

(viii) alkali and alkaline earth salts of phenoxy resins; and

(ix) alkali and alkaline earth salts of cyclodextrins, hydroxypropyl cyclodextrins , and hydroxyethyl cyclodextrins.

Alkali and alkaline earth salts can provide a reservoir of metals to prevent consumption of electrochemically active lithium in parasitic reactions, as well as providing a site to capture transition metals. While not wishing to be bound by theory, it is thought that hydroxyl groups can react with acid species from the decomposition of electrolyte solution to slow dissolution of the active metal oxide of the positive electrode, or that they or other binder functional groups can scavenge intermediates from the electrolyte solution that would otherwise form resistive films on the surface of active material particles. Preferably, the alkali salts of polymers having acid groups or hydroxyl groups are used; more preferably, the lithium salts of polymers having acid groups or hydroxyl groups are used, especially the lithium salts of polymers having acid groups.

Nonlimiting examples of homopolymers and copolymers having amine groups, isocyanate groups, urethane groups, urea groups, amide groups, and combinations of these include:

(i) amine-functional polyamides, alkali and alkaline earth carboxylate-functional polyamides, and polyamides in which carbonyl groups have been reduced via deoxygenation to form polyamines, including amine-functional Nylon-6, Nylon 6,6, Nylon 6,9, Nylon 6,10, Nylon 6,12, and Nylon 11 and the polyamines derived by reduction therefrom, as well as hydroxyalkylated polyamides and polyamines, such as hydroxymethyl, hydroxyethyl, and hydroxypropyl polyamides;

(ii) vinyl polymers and copolymers having pendent amino groups, such as any of polyvinylpyrrolidone, polyvinylpyrrolidine, and polyvinylhydroxyalkylatedpyrrolidones reduced via deoxygenation to polyamines, poly[(vinylidene chloride)-co-(allyl amine)], polyallylamine, polyvinylbenzylamine, polyvinylpyridine, polyvinylcarbazole, poly(styrene-co-allylamine], poly(vinylpyridine-co-styrene), poly[vinylpyridine-co-(acrylic acid)], poly[vinylpyridine-co-(methacrylic acid)], and poly[(methylvinyl ether)-alt-maleimide];

(iii) polyethyleneimines (linear or branched) and hydroxyalkylated polyethyleneimines where the hydroxyalkyl group is hydroxymethyl, hydroxyethyl, hydroxypropyl, and so on;

(iv) aminoalkylated celluloses, such as aminoethylated cellulose;

(v) polyacrylamide, hydroxyl-modified polyacrylamide, and polymethacrylamide;

(vi) polyvinylpyrrolidone and poly[vinylpyrrolidone-co-(vinyl alcohol)];

(vii) poly(2-ethyl-2-oxazoline) and polymers derived from hydrolysis of poly(2-ethyl-2-oxazoline);

(viii) polyamides terminated by polyamines such as diethylenetriamine and triethylenetetraamine;

(ix) poly(2-acrylamido-2-methyl-1-propanesulfonic acid);

(x) polyurethanes, which may be prepared from diisocyanates such as isophorone diisocyanate (IPDI), methylene bis-4-cyclohexyl isocyanate (H₁₂MDI), cyclohexyl diisocyanate (CHDI), m-tetramethyl xylene diisocyanate (m-TMXDI), p-tetramethyl xylene diisocyanate (p-TMXDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, 1,4-methylene bis-(cyclohexyl isocyanate), the various isomers of toluene diisocyanate, meta-xylylene diioscyanate and para-xylylenediisocyanate, 4-chloro-1,3-phenylene diisocyanate, 1,5-tetrahydro-naphthalene diisocyanate, 4,4′-dibenzyl diisocyanate, and xylylene diisocyanate (XDI), and biurets of these and combinations of these and polyols, particularly diols, such as ethylene glycol and lower oligomers of ethylene glycol including diethylene glycol, triethylene glycol and tetraethylene glycol; propylene glycol and lower oligomers of propylene glycol including dipropylene glycol, tripropylene glycol and tetrapropylene glycol; cyclohexanedimethanol, 1,6-hexanediol, 2-ethyl-1,6-hexanediol, 1,4-butanediol, 1,5-pentanediol, 1,3-propanediol, butylene glycol, neopentyl glycol, dihydroxyalkylated aromatic compounds such as the bis (2-hydroxyethyl) ethers of hydroquinone and resorcinol; p-xylene-α,α′-diol; the bis (2-hydroxyethyl) ether of p-xylene-α,α′-diol; m-xylene-α,α′-diol, polymeric diols such as polyethers, polyesters, and polycarbonates, and others including, for example, polyethylene glycol, polybutadiene-diol, hydrogenated polybutadienediol, and so on, and combinations of these, and may be used as either hydroxyl-terminated or isocyanate-terminated polymers;

(xi) polyureas, which may be prepared from diisocyanates such as those already mentioned and diamines such as unsaturated diamines such as 4,4′-diamino-diphenylmethane (i.e., 4,4′-methylene-dianiline or “MDA”) and dianiline (diphenylamine); hexanediamine, oxy-dianiline ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), N-(3-aminopropyl)-N-methyl-1,3-propanediamine), 1,4-bis(3-aminopropoxy)butane, diethyleneglycol-di(aminopropyl)ether), 1-methyl-2,6-diamino-cyclohexane, 1,4-diamino-cyclohexane, poly(oxyethylene-oxypropylene)diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, polytetramethylene ether diamines, 3,3′,5,5′-tetraethyl-4,4′-diamino-dicyclohexylmethane (i.e., 4,4′-methylene-bis(2,6-diethylaminocyclohexane)), 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine; and

(xii) melamine formaldehyde polymers and urea formaldehyde polymers;

(xiii) hydroxyalkylated polyamides and polyamines; and

(xix) hydroxyalkoxyalkylated polyamides and polyamines.

These may be used in any combination.

While not wishing to be bound by theory, it is believed that the amine groups, isocyanate groups, urethane groups, urea groups, and amide groups can react or interact with species that results from electrolyte (solvent molecules or anions) decomposition to slow or stop reactions harmful to battery performance that otherwise may occur at the surfaces of the lithium host material in the positive electrode.

The positive electrode 14 may optionally include other binder components. Nonlimiting examples of other suitable binder polymers that may be combined with the binder material with functional groups include polyvinylidene fluoride, polyacrylonitrile, polyethylene oxide, polyethylene, polypropylene, polytetrafluoroethylene, polybutadiene, polystyrene, polyalkyl acrylates and methacrylates, ethylene-(propylene-diene-monomer)-copolymer (EPDM) rubber, copolymers of styrene and butadiene, and mixtures of such polymers. When the binder includes other binder components, the binder includes at least about 10 wt. %, preferably from about 30 wt % to about 100 wt %, and more preferably about 50 wt % to about 100 wt %, and still more preferably about 70 wt % to about 100 wt % of the binder material with functional groups selected from alkali and alkaline earth salts of acid groups and hydroxyl groups, amine groups, isocyanate groups, urethane groups, urea groups, amide groups, and combinations of these.

The positive electrode materials may be combined generally in amounts of from about 80% to about 98% by weight of the active lithium-transition metal compound, from about 1% to about 10% by weight of the binder, and from about 1% to about 10% by weight of the conductive carbon filler or other electrically conductive material. The binder comprises from about 10% to about 100 by weight, preferably from about 30% to about 70% by weight of the binder material with functional groups.

The positive electrode including the binder material with functional groups may be used in a lithium-ion cell to provide a current efficiency of at least about 90% after 30 cycles, preferably a current efficiency of at least about 99% after 30 cycles. For example, a lithium-ion cell made with a positive electrode containing LiₓMn₂O₄ in a sodium alginate or lithium alginate binder and conductive carbon black filler may have a current efficiency ≧99% after 25-30 cycles even when operated at 60° C., indicating ongoing reduction of parasitic reactions with cycle number.

The positive electrode current collector 22 may be formed from aluminum or another appropriate electronically conductive material.

An electrically insulating separator 16 is generally included between the electrodes, such as in batteries configured as shown in FIG. 1. The separator must be permeable for the ions, particularly lithium ions, to ensure the ion transport for lithium ions between the positive and the negative electrode. Nonlimiting examples of suitable separator materials include polyolefins, which may be a homopolymer or a random or block copolymer, either linear or branched, including polyethylene, polypropylene, and blends and copolymers of these; polyethylene terephthalate, polyvinylidene fluoride, polyamides (nylons), polyurethanes, polycarbonates, polyesters, polyetheretherketones (PEEK), polyethersulfones (PES), polyimides (PI), polyamide-imides, polyethers, polyoxymethylene (acetal), polybutylene terephthalate, polyethylene naphthenate, polybutene, acrylonitrile-butadiene styrene copolymers (ABS), styrene copolymers, polymethyl methacrylate, polyvinyl chloride, polysiloxane polymers (such as polydimethylsiloxane (PDMS)), polybenzimidazole, polybenzoxazole, polyphenylenes, polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers, polyaramides, polyphenylene oxide, and combinations of these.

The microporous polymer separator 16 may be a woven or nonwoven single layer or a multi-layer laminate fabricated in either a dry or wet process. For example, in one example, the polymer separator may be a single layer of the polyolefin.

In another example, a single layer of one or a combination of any of the polymers from which the microporous polymer separator 16 may be formed (e.g, the polyolefin or one or more of the other polymers listed above for the separator 16). As another example, multiple discrete layers of similar or dissimilar polyolefins or other polymers for the separator 16 may be assembled in making the microporous polymer separator 16. In one example, a discrete layer of one or more of the polymers may be coated on a discrete layer of the polyolefin for the separator 16. Further, the polyolefin (and/or other polymer) layer, and any other optional polymer layers, may further be included in the microporous polymer separator 16 as a fibrous layer to help provide the microporous polymer separator 16 with appropriate structural and porosity characteristics. A more complete discussion of single and multi-layer lithium ion battery separators, and the dry and wet processes that may be used to make them, can be found in P. Arora and Z. Zhang, “Battery Separators,” Chem. Rev., 104, 4424-4427 (2004).

Suitable electrolytes for lithium-ion batteries include nonaqueous solutions of lithium salts. Nonlimiting examples of suitable lithium salts include lithium hexafluorophosphate, lithium hexafluoroarsenate, lithium bis(trifluoromethlysulfonylimide), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, and combinations of these.

The lithium salt is dissolved in a non-aqueous, inert solvent, which may be selected from: ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, or an ionic liquid, and mixtures of two or more of these solvents.

The electrolyte may further include one or more additives, such as any of those disclosed in S.S. Zhang, “J. Power Sources,” 162 (2006) 1379-1394 (available at www. sciencedirect.com).

The following examples illustrate, but do not in any way limit, the scope of the methods and compositions as described and claimed. All parts are parts by weight unless otherwise noted.

### EXAMPLES

### Example 1

### Comparison of Lithium Ion Cell Using the Lithium Salt of Polyacrylic Acid as Binder with Prior Art

The prior art lithium ion cell and the inventive lithium cell tested each had a negative electrode of graphite in a polyvinylidene fluoride binder. The prior art lithium ion cell tested had a positive electrode with a polyvinylidene fluoride binder, while the inventive lithium ion cell had a positive electrode with a binder of lithium polyacrylate. The electrochemically active, lithium-containing material in the positive electrodes of both cells was LiₓNi_{0.5}Mn_{1.5}O₄ spinel material. The negative electrodes had a 5% excess capacity compared to the respective positive electrodes. All electrodes contained 10 wt % binder material and 10 wt % conductive carbon (Li Super P) filler. The test cells were assembled with 1 M LiPF₆ salt in a mixture of ethylene carbonate (EC) and diethyl carbonate (DEC) solvents in a 1:2 ratio by volume. A commercial polypropylene micorporous membrane was used as separator in all cells.

Coin cell batteries of 2032 format were assembled inside of the inert atmosphere of an argon-filled glove box from the above described materials. Electrochemical testing was performed with a constant current corresponding to a 5 hours time for the initial charge and discharge (so-called C/5 rate), subsequent to two formation cycles at C/10 rate, between the voltage limits of 3.0 V and 4.8 V using a Maccor battery cycler, at constant temperatures of 30° C. and 45° C.

FIG. 2a is a graph of specific discharge capacity (mAh/g) (y-axis) versus number of cycles (x-axis) at 45° C. for the prior art lithium ion cell (line 1) and the inventive lithium ion cell with a positive electrode with a binder of lithium polyacrylate (line 2).

FIG. 2b is a graph of coulombic efficiency (%) (y-axis) versus number of cycles (x-axis) at 45° C. for the prior art lithium ion cell (line 1) and the inventive lithium ion cell with a positive electrode with a binder of lithium polyacrylate (line 2).

According to the graph of FIG. 2b of coulombic efficiency, the cell using the prior art positive electrode with polyvinylidene fluoride binder should have zero capacity after 4 cycles. However, the graph of FIG. 2a shows that it has a specific discharge capacity of 85 mAh/g in cycle 5. This indicates large amounts of parasitic reactions not involving the electrochemically active lithium. In comparison, the inventive cell with the positive electrode with the binder of lithium polyacrylate stops most of these parasitic reactions, as shown by a large increase in coulombic efficiency to more than 94% after cycle 1 (FIG. 2b).

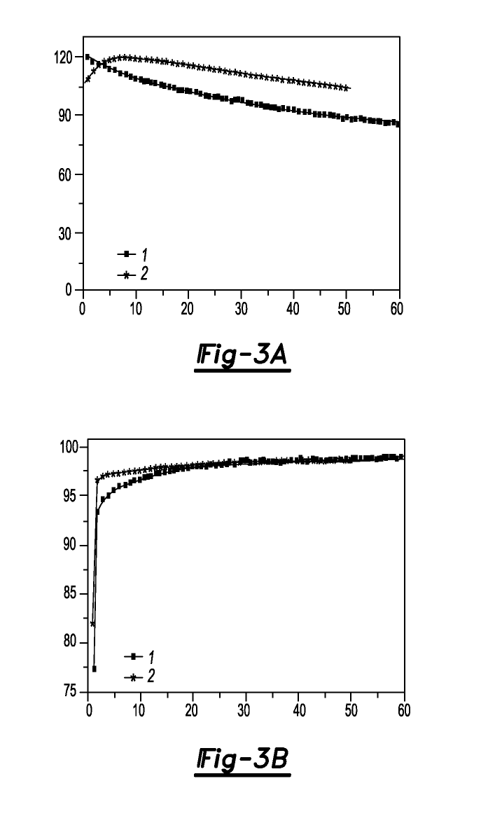

FIG. 3a is a graph of specific discharge capacity (mAh/g) (y-axis) versus number of cycles (x-axis) at 30° C. for the prior art lithium ion cell (line 1) and the inventive lithium ion cell with a positive electrode of LiₓNi_{0.5}Mn_{1.5}O₄ in a binder of lithium polyacrylate (line 2).

FIG. 3b is a graph of coulombic efficiency (%) (y-axis) versus number of cycles (x-axis) at 30° C. for the prior art lithium ion cell (line 1) and the inventive lithium ion cell with a positive electrode of LiₓNi_{0.5}Mn_{1.5}O₄ in a binder of lithium polyacrylate (line 2).

The inventive cell with the positive electrode using a binder of lithium polyacrylate (line 2) still has a higher discharge capacity and coulombic efficiency compared to the prior art cell with the positive electrode using a binder of polyvinylidene fluoride (line 1), although the difference is not as marked as at 45° C. due to slower degradation kinetics at the lower temperature. The increasing discharge capacity for the inventive cell with the positive electrode using a binder of lithium polyacrylate (line 2) of about 10 mAh/g indicates a benefit from the binder as a source of lithium. The increases in specific discharge capacity and coulombic efficiency in the first 20 cycles for the inventive cell (lines 2 in each graph) show that the binder of lithium polyacrylate helps to stop parasitic reactions, even though there is no difference in coulombic efficiency after 30 cycles.

The binder of lithium polyacrylate in the positive electrode improves cycle life and increases coulombic efficiency at both test temperatures.

### Example 2

### Comparison of Lithium Ion Cell Using Sodium Alginate as Binder with Prior Art

A prior art lithium ion cell was prepared as before. An inventive lithium ion cell was prepared as in Example 1, but using sodium alginate instead of lithium polyacrylate in the binder portion of the positive electrode. The prior art and inventive cells were tested as described in Example 1.

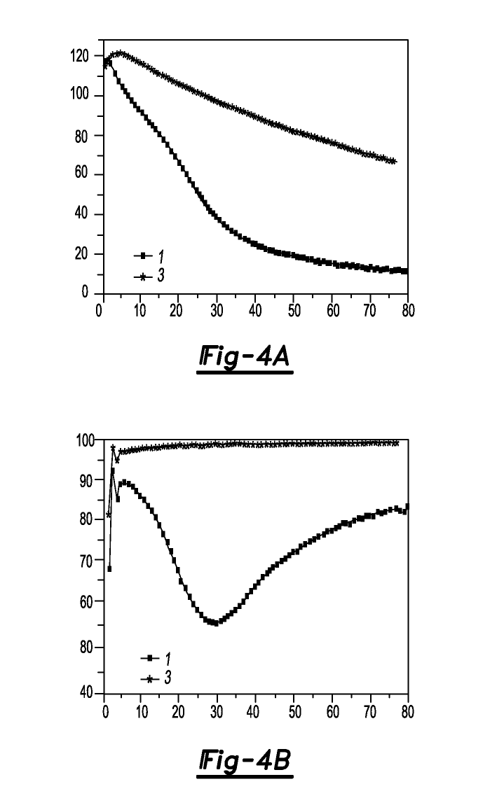

FIG. 4a is a graph of specific discharge capacity (mAh/g) (y-axis) versus number of cycles (x-axis) at 45° C. for the prior art lithium ion cell (line 1) and the inventive lithium ion cell with a positive electrode of LiₓNi_{0.5}Mn_{1.5}O₄ in a binder of sodium alginate (line 3).

FIG. 4b is a graph of coulombic efficiency (%) (y-axis) versus number of cycles (x-axis) at 45° C. for the prior art lithium ion cell (line 1) and the inventive lithium ion cell with a positive electrode of LiₓNi_{0.5}Mn_{1.5}O₄ in a binder of sodium alginate (line 3).

According to the graph of coulombic efficiency, the prior art cell using the positive electrode with polyvinylidene fluorine binder should have zero capacity after 7 cycles. However, the graph of FIG. 2a shows that it has a specific discharge capacity of 97 mAh/g in cycle 8. This indicates large amounts of parasitic reactions not involving the electrochemically active lithium. In comparison, the inventive positive electrode with the sodium alginate binder stops most of these parasitic reactions, as shown by a large increase in coulombic efficiency to more than 94% after cycle 1

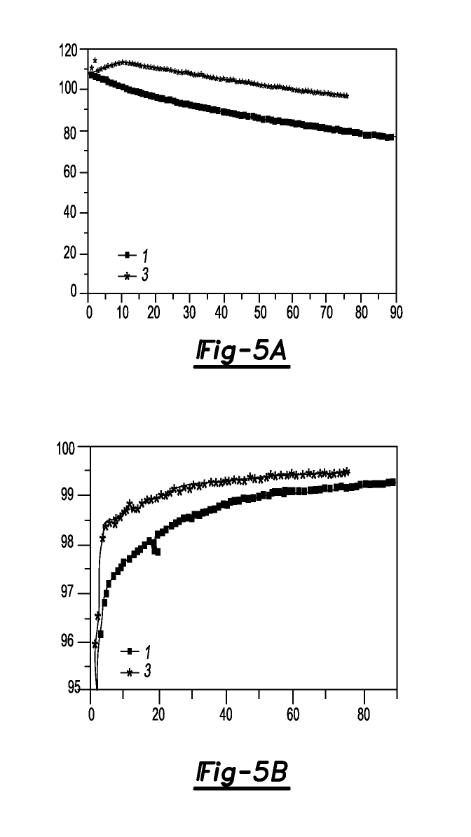

FIG. 5a is a graph of specific discharge capacity (mAh/g) (y-axis) versus number of cycles (x-axis) at 30° C. for the prior art lithium ion cell (line 1) and the inventive lithium ion cell with a positive electrode of LiₓNi_{0.5}Mn_{1.5}O₄ in the binder of sodium alginate (line 3).

FIG. 5b is a graph of coulombic efficiency (%) (y-axis) versus number of cycles (x-axis) at 30° C. for the prior art lithium ion cell with positive electrode of LiₓNi_{0.5}Mn_{1.5}O₄ in the polyvinylidene fluoride binder (line 1) and the inventive lithium ion cell with a positive electrode of LiₓNi_{0.5}Mn_{1.5}O₄ in the binder of sodium alginate (line 3).

The inventive cell with a positive electrode of LiₓNi_{0.5}Mn_{1.5}O₄ in the binder of sodium alginate (line 3) has a higher discharge capacity and coulombic efficiency compared to the prior art cell with LiₓNi_{0.5}Mn_{1.5}O₄ in the binder of polyvinylidene fluoride (line 1), indicating that the sodium alginate binder reduces parasitic reactions.

The sodium alginate binder improved cycle life and increased coulombic efficiency at both test temperatures.

The foregoing description of the embodiments has been provided for purposes of illustration and description. It is not intended to be exhaustive or to limit the invention. While the best mode and other embodiments of the invention have been described in detail, alternative designs and embodiments exist for practicing what is claimed. Individual elements or features of a particular embodiment are generally not limited to that particular embodiment, but, where applicable, are interchangeable and can be used in another embodiment, even if not specifically shown or described. Such variations are not to be regarded as a departure from the invention, and all such modifications are intended to be included within the scope of the invention.

What is claimed is:

1. A lithium-ion cell, comprising:
(a) a positive electrode comprising at least one active material comprising a lithium transition metal compound in a binder comprising at least one binder material with functional groups selected from alkali and alkaline earth salts of acid groups and hydroxyl groups, amine groups, isocyanate groups, urethane groups, urea groups, amide groups, and combinations of these;
(b) a negative electrode comprising metallic lithium or a lithium host material;
(c) a nonaqueous solution of a lithium salt; and
(d) an electrically nonconductive, ion-pervious separator positioned between the electrodes.

2. A lithium-ion cell according to claim 1, wherein the binder material comprises at least one member selected from the group consisting of:
(i) alkali and alkaline earth salts of polymers and copolymers of ethylenically unsaturated acids;
(ii) alkali and alkaline earth salts of carboxylated polyvinyl chloride;
(iii) alkali and alkaline earth salts of polyvinyl alcohol and copolymers with vinyl alcohol monomer units;
(iv) alkali and alkaline earth salts of polysaccharides;
(v) alkali and alkaline earth salts of polyundecylenol and copolymers of olefins and undecylenol, polyundecylenic acid and copolymers of olefins and undecylenic acid;
(vi) alkali and alkaline earth salts of maleated polymers and fumarated polymers and monoesters thereof;
(vii) alkali and alkaline earth salts of homopolymers and copolymers of ethylenically unsaturated alcohols;
(viii) alkali and alkaline earth salts of phenoxy resins;
(ix) alkali and alkaline earth salts of cyclodextrins, hydroxypropyl cyclodextrins , and hydroxyethyl cyclodextrins;
and combinations thereof

3. A lithium-ion cell according to claim 1, wherein the binder material comprises at least one member selected from the group consisting of:
(i) amine-functional polyamides, alkali and alkaline earth carboxylate-functional polyamides, hydroxyalkylated polyamides, and polyamides that have been reduced to polyamines and hydroxyalkylated polymers derived therefrom;
(ii) vinyl polymers and copolymers having pendent amino groups;
(iii) polyethyleneimines and hydroxyalkylated polyethyleneimines;
(iv) aminoalkylated celluloses;
(v) polyacrylamide, hydroxyl-modified polyacrylamide, and polymethacrylamide;
(vi) polyvinylpyrrolidone and poly[vinylpyrrolidone-co-(vinyl alcohol)] and amine polymers derived therefrom;
(vii) poly(2-ethyl-2-oxazoline) and hydrolyzed poly(2-ethyl-2-oxazoline);
(viii) polyamides terminated by polyamines;
(ix) poly(2-acrylamido-2-methyl-1-propanesulfonic acid);
(x) polyurethanes;
(xi) polyureas;
(xii) melamine formaldehyde polymers and urea formaldehyde polymers;
(xiii) hydroxyalkylated polyamides and polyamines;
(xix) hydroxyalkoxyalkylated polyamides and polyamines;
and combinations thereof

4. A lithium-ion cell according to claim 1, wherein the binder material has functionality selected from the group consisting of alkali and alkaline earth salts of acid groups and hydroxyl groups.

5. A lithium-ion cell according to claim 1, wherein the binder material has functionality selected from the group consisting of lithium and sodium salts of acid groups and hydroxyl groups.

6. A lithium-ion cell according to claim 1, wherein the binder material is selected from the group consisting of lithium polyacrylate, lithium polymethacrylate, lithium alginate, lithium carboxymethyl cellulose, lithium polyvinyl alcohol, lithium β-cyclodextrin, sodium polyacrylate, sodium polymethacrylate, sodium alginate, sodium carboxymethyl cellulose, sodium polyvinyl alcohol, sodium β-cyclodextrin, and combinations of these.

7. A lithium-ion cell according to claim 1, wherein the positive electrode binder comprises from about 10 wt. % to about 100 wt. % of the binder material with functional groups.

8. A lithium-ion cell according to claim 1, wherein the positive electrode binder comprises from about 70 wt. % to about 100 wt. % of the binder material with functional groups.

9. A lithium-ion cell according to claim 1, wherein the positive electrode comprises at least one member selected from the group consisting of lithium manganese compounds, lithium nickel compounds, lithium iron compounds, and lithium cobalt compounds.

10. A lithium-ion cell according to claim 1, wherein the positive electrode comprises a lithium manganese compound.

11. A lithium-ion cell according to claim 1, wherein the negative electrode comprises graphite or other carbonaceous compound, silicon or silicon compound, or a transition metal oxide .

12. A method of making a lithium-ion battery, comprising forming a positive electrode from a lithium transition metal compound and a binder comprising at least one binder material with functional groups selected from the group consisting of alkali and alkaline earth salts of acid groups and hydroxyl groups, amine groups, isocyanate groups, urethane groups, urea groups, amide groups, and combinations of these.

13. A method according to claim 12, wherein the positive electrode comprises at least one member selected from the group consisting of lithium manganese compounds, lithium nickel compounds, lithium iron compounds, and lithium cobalt compounds.

14. A method according to claim 12, wherein the positive electrode comprises the binder material with functional groups in an amount sufficient to provide a current efficiency of at least about 95% after 30 cycles.

15. A method according to claim 12, wherein the positive electrode comprises the binder material with functional groups in an amount sufficient to provide a current efficiency of at least about 99% after 30 cycles.

16. A method according to claim 12, wherein the binder material with functional groups is selected from the group consisting of lithium polyacrylate, lithium polymethacrylate, lithium alginate, lithium carboxymethyl cellulose, lithium polyvinyl alcohol, lithium β-cyclodextrin, sodium polyacrylate, sodium polymethacrylate, sodium alginate, sodium carboxymethyl cellulose, sodium polyvinyl alcohol, sodium β-cyclodextrin, and combinations of these.

17. A method according to claim 12, wherein the binder material with functional groups comprises sodium alginate or lithium alginate.

18. A positive electrode comprising at least one active material comprising a lithium transition metal compound and a binder comprising at least one binder material with functional groups selected from alkali and alkaline earth salts of acid groups and hydroxyl groups, amine groups, isocyanate groups, urethane groups, urea groups, amide groups, and combinations of these.

19. A positive electrode according to claim 18, having a binder comprising from about 10 wt. % to about 100 wt. % of the binder material with functional groups.

20. A positive electrode according to claim 18, having a binder comprising from about 70 wt. % to about 100 wt. % of the binder material with functional groups.
